(19) United States
(12) Patent Application Publication
(10) Pub. No.: US 2009/0122148 A1
(43) Pub. Date: May 14, 2009

(54) DISJOINT LIGHT SENSING ARRANGEMENTS AND METHODS THEREFOR

(76) Inventors: Keith G. Fife, Palo Alto, CA (US); H.S. Philip Wong, Stanford, CA (US); Abbas El Gamal, Palo Alto, CA (US)

Correspondence Address: CRAWFORD MAUNU PLLC, 1150 NORTHLAND DRIVE, SUITE 100, ST. PAUL, MN, 55120, US

(21) Appl. No.: 12/209,979

(22) Filed: Sep. 12, 2008

Related U.S. Application Data
(60) Provisional application No. 60/972,654, filed on Sep. 14, 2007.

(51) Int. Cl. H04N 5/225

(52) U.S. Cl. 348/218.1; 348/E05.024

(57) ABSTRACT

Imaging is carried out using multiple views (e.g., from a single monolithic device) to generate an image. According to an example embodiment, a scene is imaged using disjoint sensors beyond a designated focal plane to obtain multiple views of common points in the focal plane. For the common points, the multiple views are processed to compute a depth of field, and the computed depth of field to generate an image.

### RELATED PATENT DOCUMENTS

This patent document claims the benefit, under 35 U.S.C. § 119(e), of U.S. Provisional Patent Application Ser. No. 60/972,654, entitled “Light Sensor Arrangement” and filed on Sep. 14, 2007, which is fully incorporated herein by reference.

### FIELD OF THE INVENTION

The present invention relates generally to imaging, and more particularly to the imaging of a scene using disjoint light sensors.

### BACKGROUND

In recent years, digital imaging has grown tremendously in both complexity and capability, and has achieved relatively high resolution to produce desirable images for a variety of applications. For example, cameras, video cameras, robotics, biometrics, microscopes, telescopes, security and surveillance applications use digital imaging extensively.

For many applications, pixel scaling in image sensors has aimed at increasing spatial resolution for a given optical format. However, as pixel size is approaching the practical limits of optics, the improvement in resolution is diminishing. In addition, there are other undesirable conditions such as those relating to increased cross-talk and decreased fill factor which require further costly process modifications to remedy even if the optics can resolve to the scaled dimensions. Indeed, scaling pixels into the sub-micron range has not been readily desirable.

Another aspect of digital imaging that has been challenging relates to the determination of the depth of field as applicable, for example, to three-dimensional (3D) imaging. In recent years, several 3D imaging systems implementing a variety of techniques such as stereo-vision, motion parallax, depth-from focus, and light detection and ranging (LIDAR) have been reported. In particular, multi-camera stereo vision systems infer depth using parallax from multiple perspectives, while time-of-light sensors compute depth by measuring the delay between an emitted light pulse (e.g., from a defocused laser) and its incoming reflection. However, these systems are relatively expensive, consume high power, and require complex camera calibration. Moreover, imaging approaches that use active illumination, although accurate, generally employ large pixels and thus exhibit relatively low spatial resolution for a given format.

The above characteristics have continued to present challenges to digital imaging applications.

### SUMMARY

The present invention is directed to overcoming the above-mentioned challenges and others related to the types of applications discussed above and in other applications. These and other aspects of the present invention are exemplified in a number of illustrated implementations and applications, some of which are described below, shown in the figures and characterized in the claims section that follows.

According to an example embodiment of the present invention, a scene is imaged using disjoint sensors beyond a designated focal plane to obtain multiple views of common points in the focal plane. For the common points, the multiple views are processed to compute a depth of field, and the computed depth of field is used to generate an image.

According to another example embodiment of the present invention, a scene is imaged using a monolithic sensor arrangement having an array of optically disjoint sensors with sensor-specific integrated optics to re-image a focal plane formed from the scene.

In another example embodiment of the present invention, an integrated image sensor circuit includes a plurality of disjoint sensors in a sensor plane, each sensor including local integrated optics and pixels to re-image a focal plane formed from a scene. For certain applications, the circuit arrangement further includes an image data processing circuit that processes data from each sensor to generate an image and/or compute the depth of field of one or more objects in the scene.

The above summary is not intended to describe each illustrated embodiment or every implementation of the present invention.

### BRIEF DESCRIPTION OF THE DRAWINGS

The invention may be more completely understood in consideration of the detailed description of various embodiments of the invention that follows in connection with the accompanying drawings, in which:

FIG. 1 shows a sensor system for imaging, according to an example embodiment of the present invention;

FIG. 2A shows an integrated sensor array, according to another example embodiment of the present invention;

FIG. 2B shows a frame transfer charge-coupled device (FT-CCD) for implementation with an integrated sensor array, according to another example embodiment of the present invention;

FIGS. 3A-3D show an approach to depth extraction, according to another example embodiment of the present invention;

FIG. 4A and FIG. 4B show an approach to determining the depth of field, according to another example embodiment of the present invention;

FIG. 5 shows a multi-aperture image sensor chip, according to another example embodiment of the present invention;

FIG. 6 shows a charge-coupled device (CCD) schematic and device cross-sections of n FFT-CCD array, as implemented in connection with another example embodiment of the present invention;

FIG. 7 shows a timing diagram for a multi-aperture imaging device as shown in FIG. 5, according to another example embodiment of the present invention;

FIG. 8 shows a column-level analog-digital circuit (ADC) with a timing diagram for a multi-aperture imaging device, according to another example embodiment of the present invention; and

FIG. 9 shows a particular application for chip operation including vertical to horizontal transfer, according to another example embodiment of the present invention.

While the invention is amenable to various modifications and alternative forms, examples thereof have been shown by way of example in the drawings and will be described in detail. It should be understood, however, that the intention is not to limit the invention to the particular embodiments shown and/or described. On the contrary, the intention is to cover all modifications, equivalents, and alternatives falling within the spirit and scope of the invention.

### DETAILED DESCRIPTION

The present invention is believed to be applicable to a variety of different types of imaging applications. While the present invention is not necessarily so limited, various aspects of the invention may be appreciated through a discussion of examples using this context.

In connection with various example embodiments, a multi-aperture image sensor images a scene using multiple views of the same points in a primary focal plane. The magnification of local optics and the pixel size for each sensor set spatial resolution, which is greater than the aperture count. For various embodiments, small pixels are used to facilitate high depth resolution with a relatively consistent (or otherwise limited) spatial resolution. Many embodiments also involve the extraction of a depth map of the scene by solving a correspondence problem between the multiple views of the same points in the primary focal plane.

In some embodiments, a multi-aperture image sensor architecture is used in color imaging. A per-aperture color filter array (CFA) is used to mitigate or largely eliminate color aliasing and crosstalk problems similar to those that can result from the large dielectric stack heights relative to pixel size in image sensors such as sub-micron CMOS image sensors.

In connection with another example embodiment, a single-chip multi-aperture image sensor simultaneously captures a two-dimensional (2D) image and three-dimensional (3D) depth map of scenes in high resolution. Depth is inferred using multiple, localized images of a focal plane, and without necessarily implementing an active illumination source and/or requiring complex camera calibration. Certain applications involve the use of a lens or lens arrangement to focus a scene to a particular focal plane, and other applications do not involve lenses. The sensor is readily formed using one or more manufacturing approaches such as lithographic definition with semiconductor processing, and is thus amenable to the manufacture of low cost, miniaturized imaging and/or vision systems.

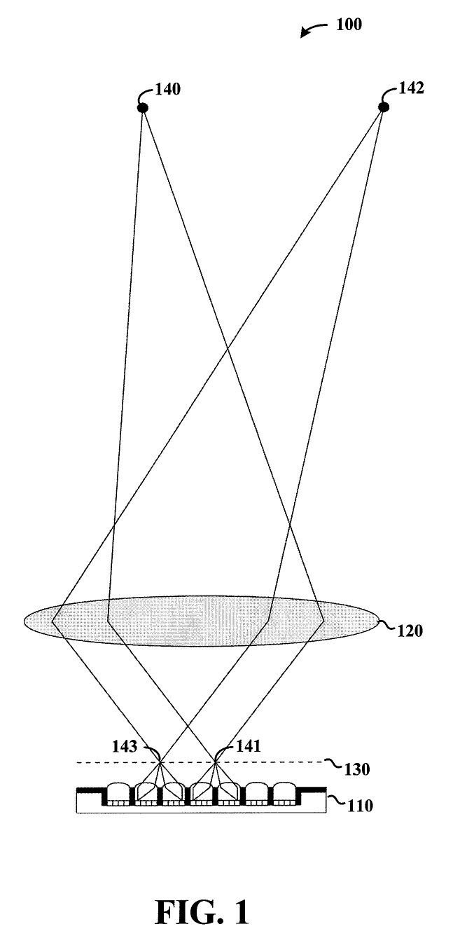

Turning now to the figures, FIG. 1 shows a system 100 for generating an image of a scene, according to another example embodiment of the present invention. The system 100 includes a multi-aperture sensor arrangement 110 that receives and processes light from a scene to form an image, using two or more views of points in a focal plane. By way of example, the system 100 is shown with an objective lens 120 that focuses light from a scene to a focal plane 130, with the light continuing past the focal plane to the multi-aperture sensor arrangement 110.

Two points 140 and 142 of a scene are shown with exemplary light rays traced through the objective lens, focused upon the focal plane 130 to points 141 and 143 (respectively corresponding to points 140 and 142). The rays diverge beyond the focal plane and are sensed or otherwise detected at separate image sensors in the multi-aperture sensor arrangement 110.

Different sensors in the multi-aperture sensor arrangement, each sensor having one or more pixels that receive light corresponding to a particular aperture, are responsive to light in the scene by generating light data. This data is processed, relative to the position of the sensors and the optics (objective 120) to compute an image, using different views of the common points (141, 143) in the focal plane 130.

The objective lens 120 effectively has no aperture from the perspective of the multi-aperture sensor arrangement 110. This facilitates a relatively complete description of the wavefront in the focal plane. The amount of depth information that can be extracted from image data relates to the total area of the objective lens that is scanned by the multi-aperture sensor arrangement 110 and can be accordingly set to suit particular applications.

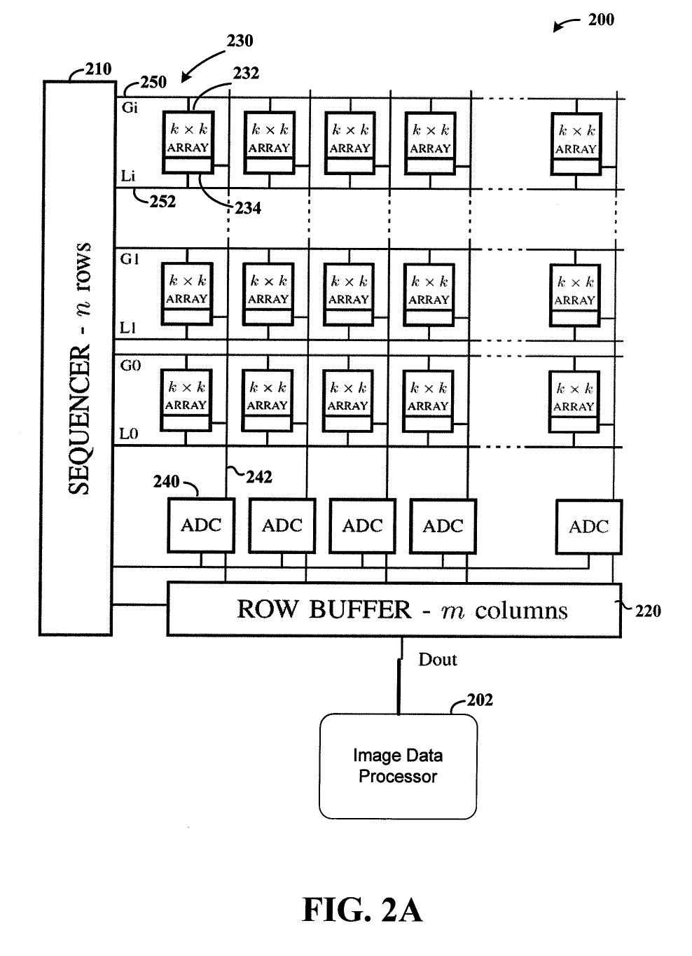

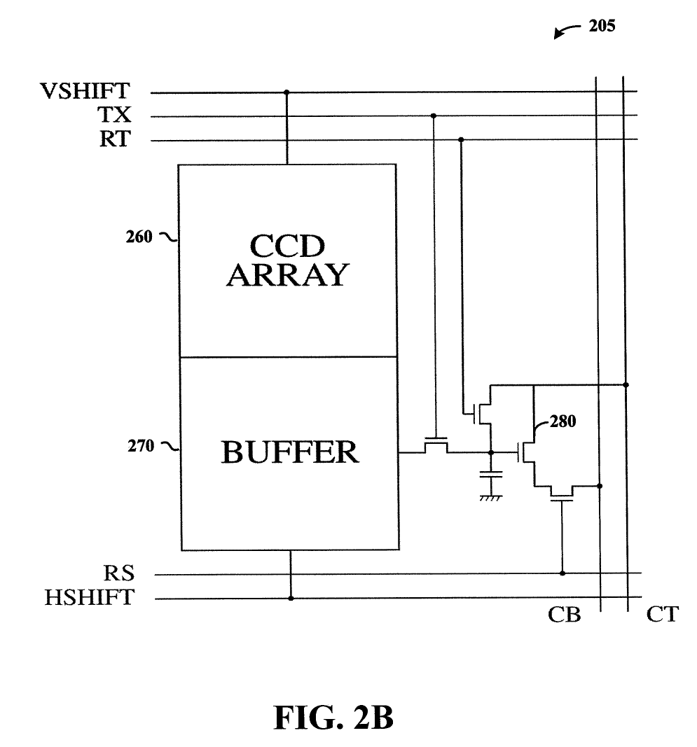

FIG. 2A shows a multi-aperture integrated sensor 200, according to another example embodiment of the present invention. The integrated sensor 200 may be implemented in connection with optics (e.g., in a manner similar to the implementation of the multi-aperture sensor arrangement 110 in FIG. 1) or without optics. Generally, the integrated sensor 200 includes an array of aperture devices, with device 230 labeled by way of example. Each aperture device includes individual apertures and light-sensing circuitry, its own local optics, a pixel array and a readout circuit to process and/or provide image data generated by the pixel array in response to light incident upon the array. A row sequencer 210 controls sequencing for “n” rows, each coupled and a row buffer 220 processes data for “m” columns as received from an analog-digital converter and the row buffer outputting data characterizing light detected from a scene. The output data is sent to an image data processor 202 that processes the data by, for example, computing a depth of field, computing an image, or otherwise generating information that can be used to characterize light data generated by the integrated sensor 200 and/or corresponding to an imaged scene.

An aperture device 230 is labeled by way of example and is used here for illustration, with the following discussion applicable to more (or all) of the aperture devices in the integrated sensor 200. The aperture device 230 includes a k×k array 232 of pixels and readout circuitry 234. Where appropriate, local optics are implemented for each aperture device, such as in the dielectric stack of an integrated circuit including the aperture devices and using refractive microlenses or diffractive gratings patterned in metal layers in the integrated circuit. Each aperture device is separated from adjacent aperture devices, which facilitates the implementation of the readout circuitry and local optics immediately adjacent to the pixel array.

In these contexts, the “k×k” pixel array refers to an array of pixels that may be set to a number of pixels to suit a particular application, such as a 2×2 array. Other embodiments use pixel arrays having more or fewer rows than columns (e.g., a 1×2 array), or pixels that are not in an array and/or sporadically arranged. The independent apertures with localized pixels facilitate aggressive pixel scaling, which is useful for achieving high depth resolution.

The aperture device 230 is coupled to the sequencer 210 via connectors 250 and 252, and is further connected to analog-digital converter (ADC) 240 via column connector 242. The integrated sensor 200 includes a multitude of such aperture devices, respectively coupled to rows and columns that may include more or fewer rows and columns as shown (and represented by dashed lines representing expansion or reduction). Hence, the “n” rows and “m” columns may respectively include more or fewer rows or columns, relative to that shown in FIG. 2A.

In connection with certain embodiments, unlike a conventional imaging system where the lens focuses the image directly onto the image sensor, the image is focused above the sensor plane (e.g., at focal plane 130 in FIG. 1) and re-imaged to form partially overlapping images of a scene. The captured images are combined to form the 2D and 3D representations of the scene.

In some embodiments, each aperture device is optically disjoint, or separated, from all other aperture devices. That is, each aperture device operates independent from other aperture devices, and each aperture provides an independent signal representing light detected by the aperture. In some applications, each aperture device is separated by a distance that mitigates and/or prevents any crosstalk between the sensors for light detected thereby. In some applications, each aperture device is separated a physical structure such as a wall of stacked via and metal layers. In addition and in connection with various embodiments, the array of aperture devices are monolithic (e.g., formed on a common silicon chip). In other embodiments, the entire integrated sensor is monolithic.

FIG. 2B shows an aperture device 205 having a frame transfer charge-coupled device (FT-CCD), for use in an integrated sensor such as integrated sensor 200 in FIG. 2A, according to another example embodiment of the present invention. Desirable readout performance is achieved using a relatively small array size with modest charge transfer efficiency. With relatively low charge transfer requirements, the aperture device 205 is feasible for implementation in CMOS circuits with certain (minor) process modifications.

The aperture device 205 includes a light sensitive CCD array 260 of k×k pixels and a light shielded CCD array of k x k storage cells. The pixels in the entire image sensor are set to integrate simultaneously via global control. Such global shuttering is useful to achieve highly accurate correspondence between apertures in extracting depth. After integration, the charge from each pixel array is shifted into its local frame buffer 270 and then read out through a floating diffusion node via a follower amplifier at 280. A correlated double sampling scheme is used for low temporal and fixed-pattern noise. Global readout is performed using hierarchal column lines that may be similar, for example, to hierarchal bit/word lines used in low-power SRAM. Column-level ADCs digitize sensor data for fast readout and/or on-chip parallel processing.

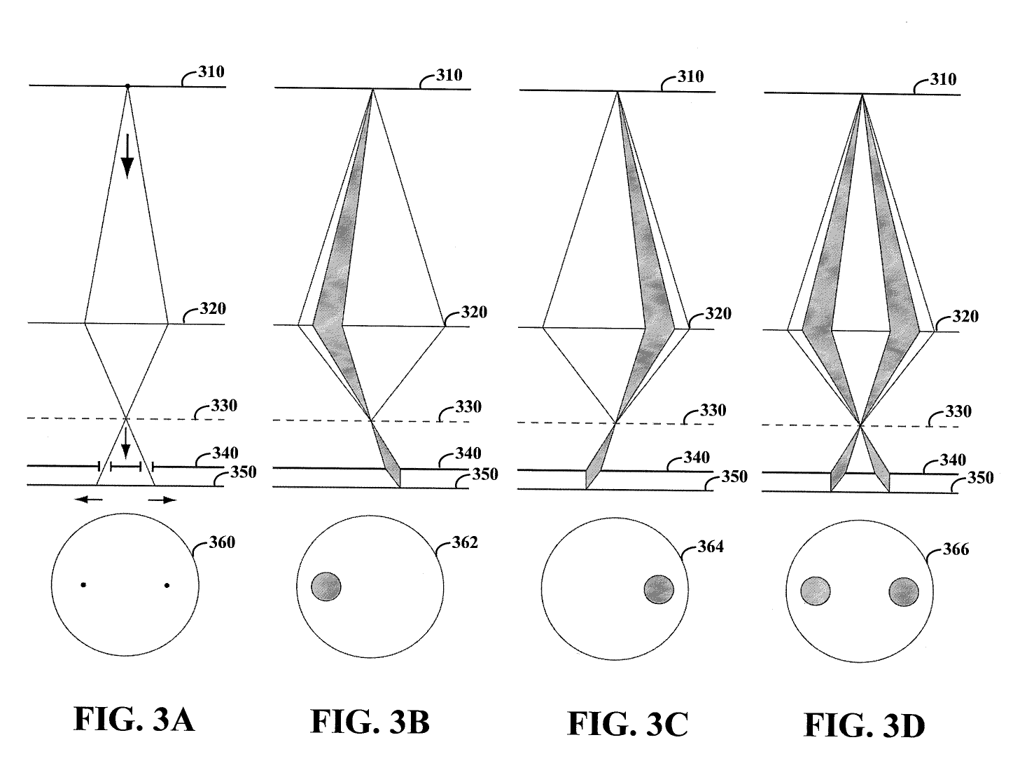

In connection with various example embodiments, the depth of objects in a scene is obtained using the disparity between apertures (with the term apertures referring generally to an image sensor arrangement, such as those discussed in connection with FIG. 2A, involving one or more of pixels, processing circuitry and optics). In these contexts, FIGS. 3A, 3B, 3C and 3D show an approach to depth extraction with ray-tracing, according to various example embodiments. Generally, each figures shows the imaging of a scene at 310, with light passed via an objective lens 320, which focuses the light to a focal plane 330, beyond which an aperture array (340, 350) lies. The circles 360, 362, 364, 366 below the aperture array for each of FIGS. 3A, 3B, 3C and 3D respectively show the location at which light rays pierce the objective lens 320 in an area of the objective lens that is used by each aperture.

Beginning with FIG. 3A, chief ray traces for an object in scene 310 are shown, as the object is imaged from apertures 340 behind an objective lens 320. The circle 360 below the diagram shows the location at which the chief ray pierces the objective lens 320. As the object moves back and forth, the object in the focal plane 330 (above the sensor) moves back and forth with some attenuation in magnitude governed by the lens law. The movement of the object in the secondary images formed by the local optics is lateral. The amount of lateral displacement between multiple apertures is used to represent the depth of the object. In this context, several apertures are selectively placed with respect to each other to facilitate the reliable determination of depth.

Marginal ray traces for the same point as seen from the two different apertures are shown in FIGS. 3B, 3C and 3D. In this regard, a virtual stereo pair is projected up to the plane of the objective lens. The characteristics of the apertures remain constant across the array without spatial compensation, especially as the objective lens maintains telecentricity. For example, at nominal object distance, only a small number of apertures sample any given point in the object plane. As the object moves to further distances, more apertures capture its information. Therefore, both the position of objects within each aperture and the total number of apertures imaging the same point are used as indicators of depth. Since the redundancy between apertures is localized across the focal plane, spatial resolution continues to scale as more apertures are added. To increase depth resolution, pixel size is selectively scaled down, and in some instances, scaled below the diffraction limit. While it is difficult to scale pixels to this level in a large, uniform array, optically disjoint arrays such as those shown in FIG. 2A facilitate such aggressive pixel scaling. In this context, disjoint or optically disjoint arrays are those arrays that are separated optically, such that adjacent arrays are generally not susceptible to receiving common light rays.

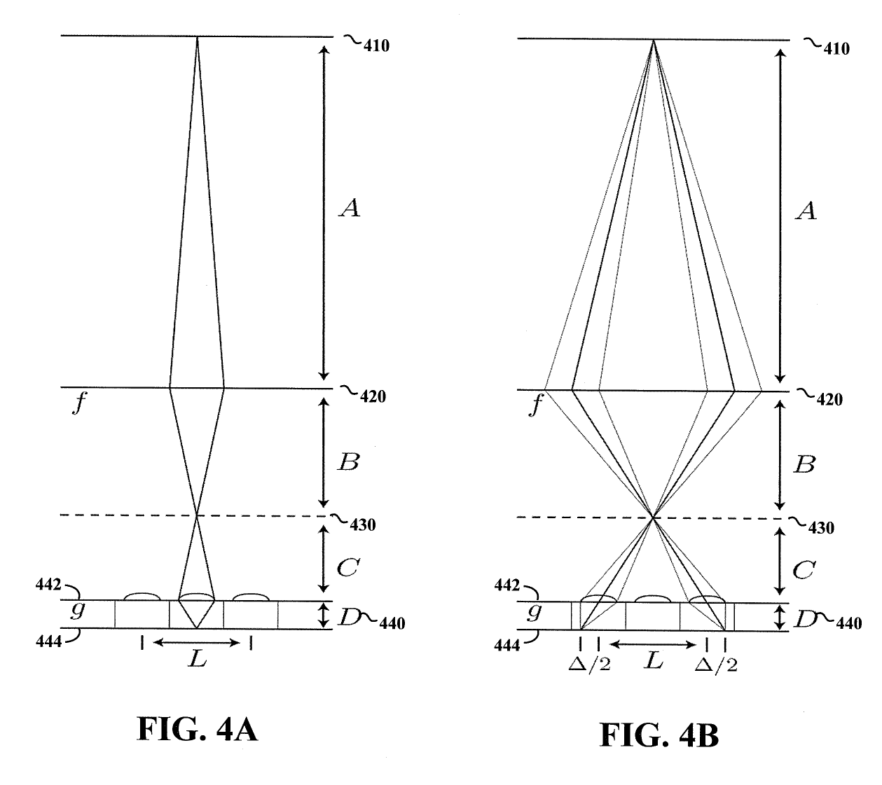

FIG. 4A and FIG. 4B show an approach to determining the depth of field, according to another example embodiment of the present invention. Each figure respectively shows a scene 410 that is imaged using an objective lens 420 to focus the scene to a focal plane 430. Light from the objective lens is passed through the focal plane 430 and to an integrated aperture sensor 440 that includes individual sensors having optics at 442 that focus light to pixels at 444.

Considering the parameters A, B, C, D and L shown in FIG. 4A, the distance E is defined as E=B+C, and the magnification factors M=B/A and N=D/C. The distance E is fixed for a given object range, and the other variables B, C, D, M, and N are all driven by the object distance A. Given a nominal object distance A₀, other parameters (distances) are denoted by B₀, C₀, D₀, M₀, and N₀, each relating to their respective indicated positions for a particular application. As A varies, the distance E is adjusted to achieve desired local magnification No for the secondary image focused at D₀. This approach is similar to adjusting the focus in a camera.

When local optics for each sensor are implemented in a dielectric stack (e.g., as discussed above), the distance D₀ is approximately equal to the dielectric stack height of the fabrication process, or the nominal distance to the secondary focal plane from the local optics. Thus, given the stack height D₀, the focal length g is set during fabrication to meet the desired N₀ value. For instance, one such application is implemented as follows. The focal length, f, is set to 10 mm, A₀=1 m, D₀=10 μm, and g=8 μm. These parameters yield a nominal magnification factor of N₀=¼. This value is set to achieve a desired amount of overlap between aperture views.

The distance D is determined as a function of A by fixing the parameters to meet the nominal magnification factor N₀. To characterize the depth of field, the deviation in D is found from the nominal position D₀ where it is in best focus. Since the local optics collect light across the entire aperture, the focus is degraded with deviation in D. By the lens law,

1/ƒ=1/A+1/B, and 1/g=1/C+1/D.
Using the magnification factors M and N, B and D are solved to obtain

B=(M+1)ƒ, and D=(N+1)g, or D=(1/g−1/C)⁻¹

$$D = {[ \frac{1}{g} - \frac{1}{( E - B )} ]}^{- 1} = {[ \frac{1}{g} - \frac{1}{\frac{{D}_{0}}{{N}_{0}} + ( {M}_{0} - M ) f} ]}^{- 1}$$

This establishes a relationship between A and D in terms of the magnification M. Consistent with the above expression for D, as the object moves to infinity, the total movement in the primary focal plane is M₀f. The total movement in the secondary focal plane is further reduced from this value, which results in a relatively wide range of focus. For instance, the movement in the primary focal plane is 100 μm for an object distance of 1 m to infinity. This translates into a mere 1:5 μm deviation in D. The magnification factor N varies from ¼ to 1/16.

Referring to FIG. 4B, an example approach to obtaining an expression for depth is as follows. The parameter L represents the distance between a pair of apertures and Δ is the displacement of the image between apertures. The distance A is estimated from Δ and E is adjusted to meet the desired magnification N₀ according to the other fixed parameters. The geometry of the configuration from the sensor to the primary focal plane gives:

C/L=D₀/Δ.

Using the lens law for A as a function of B and making the substitution B=E−C=B₀+C₀−C, we obtain

$$A = {( \frac{1}{f} - \frac{1}{B} )}^{- 1} = {( \frac{1}{f} - \frac{1}{{B}_{0} + {C}_{0} - C} )}^{- 1} .$$

Solving for A in terms of Δ gives the depth equation

$$A = {[ \frac{1}{f} - \frac{1}{( {M}_{0} + 1 ) f + \frac{{D}_{0}}{{N}_{0}} - {D}_{0} L / Δ} ]}^{- 1} .$$

A characteristic of this sensor is that the amount of depth information available is a strong function of the object distance (the closer the object, the higher the depth resolution). This is quantified by solving for A in terms of M, which gives

$$Δ = \frac{{D}_{0} L}{( {M}_{0} - M ) f + \frac{{D}_{0}}{{N}_{0}}} .$$

As M increases, Δ rapidly approaches its limit of D₀L/(M₀ƒ+D₀/N₀).

The rate of change in Δ with A, i. e., δΔ/δA, can be computed as a function of δB/δA and δΔ/δC. Setting δC=−δB at the focal plane, it can be shown that

$$\partial Δ / \partial A \approx - \frac{{f}^{2}}{{A}^{2}} \frac{DL}{{C}^{2}} \to \frac{\partial Δ}{\partial A} \approx - {M}^{2} {N}^{2} \frac{L}{D} .$$

For example, with a 0.5 μm pixel pitch, the displacement between apertures can be estimated to within about 0.5 μm resolution. Further, assuming L/D=2, the incremental depth resolution δA is approximately 4 cm at A₀=1 m and 4 mm at A₀=10 cm. Decreasing pixel size allows for more accuracy in δΔ, leading to higher depth resolution.

Spatial resolution and related pixel size and sensor placement for various applications as discussed herein are set to suit various applications. In some applications, overlapping fields of view are established by setting the magnification factor of local optics to N<1. With each pixel projected up to the focal plane by a factor of 1/N, spatial resolution is reduced by 1=N². Thus, the total available resolution is about mnk²N². Using a 16×16 array of 0.5 μm pixels with a magnification factor of N₀=¼, the maximum resolution is 16 times greater than the aperture count itself, but 16 times lower than the total number of pixels.

The actual spatial resolution is limited by optical aberrations and ultimately by diffraction. The minimum spot size W for a diffraction limited system is about λ/NA, where NA=nᵢ sin θ is the numerical aperture of the local optics, nᵢ is the index of refraction of the dielectric and θ is the angle between the chief and the marginal rays. Using the Rayleigh criterion, the minimum useful pixel pitch is commonly assumed to be half the spot size. Assuming nᵢ≈1.5 in the dielectric stack, NA can be about 0.5, which gives a spot size of about 1 μm. Thus, scaling the pixel beyond 0.5 μm does not increase spatial resolution. Although no further increase in spatial resolution is feasible beyond the diffraction limit, depth resolution continues to improve as long as there are features with sufficiently low spatial frequencies. The disparity between apertures can be measured at smaller dimensions than set by the diffraction limit.

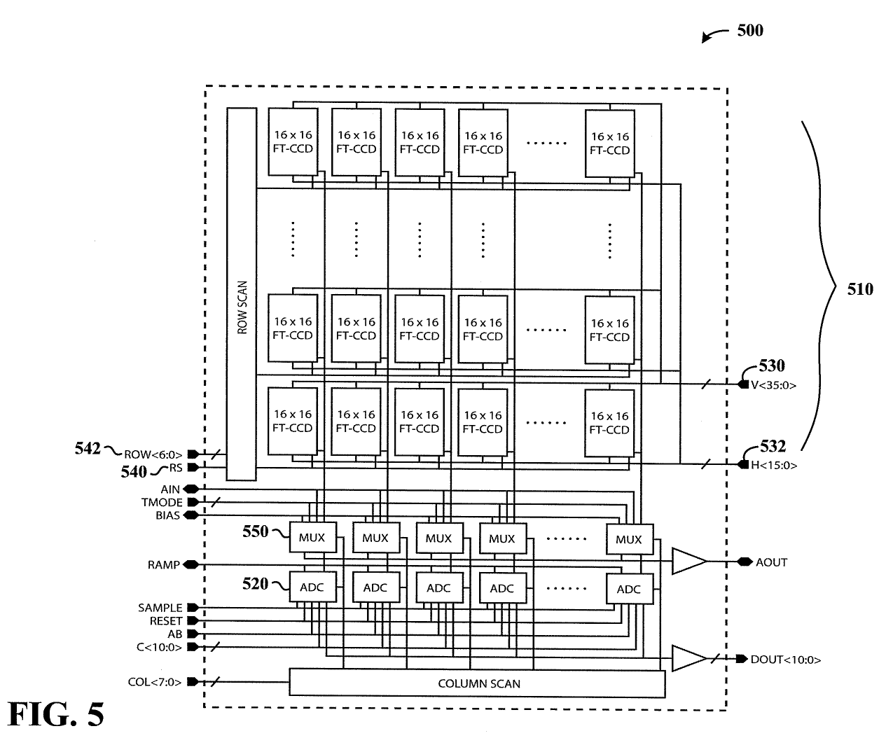

FIG. 5 shows a multi-aperture image sensor chip 500, according to another example embodiment of the present invention. The chip 500 includes a 166×76 array 510 of 16×16, 0.7 μm FFT-CCDs, CMOS APS readout, 76 per-column ADCs (with ADC 520 labeled by way of example), and bias, control and readout circuits fabricated in 110 nm CMOS technology. Aperture control buses 530 and 532 are globally connected to the FFT-CCD array 510.

To individually address a row of FFT-CCDs, an RS signal 540 is applied in conjunction with a decoded ROW signal 542. MUX blocks (with block 550 labeled by way of example) contain column control, bias circuits, and support for external testing of the analog signal chain and single column analog readout. All ADCs share an output bus, which is controlled by the signal COL and buffered at the IO.

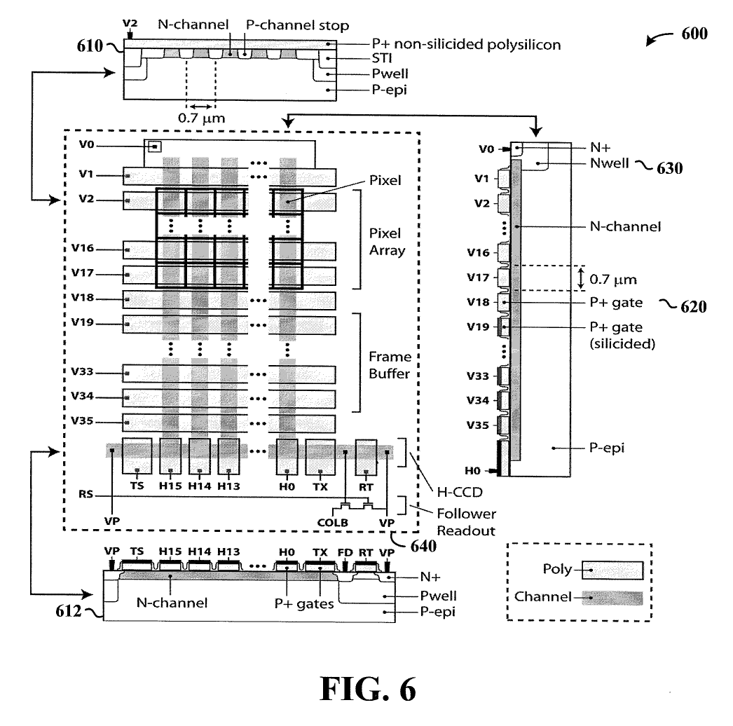

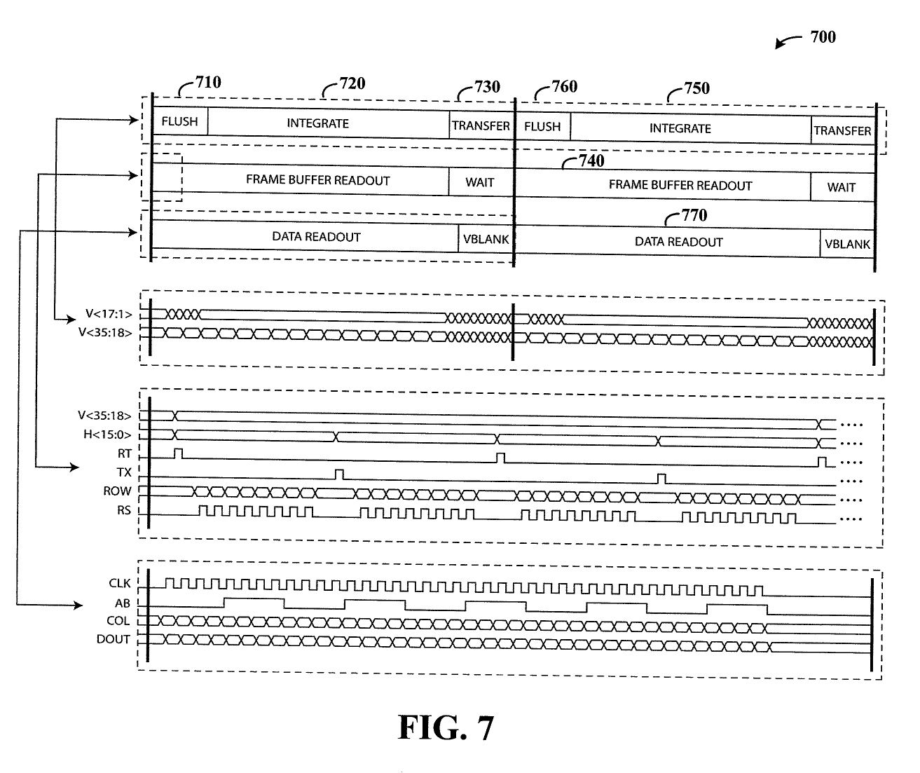

FIG. 6 shows a charge-coupled device (CCD) schematic 600 and device cross-sections 610, 612 of the 16×16 FFT-CCD array 510 shown in FIG. 7, as implemented in connection with another example embodiment of the present invention. The active area of the CCD is created with non-silicided P+polysilicon electrodes 620. N-type CCD channel and p-type channel stop implants are processed before poly. Inputs to the channels at the top of the array are connected to VO through an Nwell implant 630. This allows the p-type stops to extend out over the Nwell and connect to ground with contacts to Metal 1. Vertical channels extend into the horizontal CCD which leads to a floating diffusion node with a drain-side row select device for a follower output. Two sides of the CCD contain a signal called VP (640) that is used as a fill/spill input, reset voltage and the source follower drain supply. Both the channel stops and the polysilicon electrodes are placed at 0.7 μm pitch.

For certain applications, in order to achieve a high well capacity, the image is captured in 2 fields in the vertical direction. This allows for large barriers between pixels where charge is confined on every other electrode. A transfer from the vertical register to the horizontal register is performed with one charge packet at a time using ripple charge transfer. An STI region is used to create isolation between arrays and also serves as the area for contacts to the non-silicided electrodes.

FIG. 7 shows a timing diagram 700 for a multi-aperture imaging device shown in FIG. 5, according to another example embodiment of the present invention. The FFT CCDs are effectively used to achieve a global shutter. Integration time is adjusted with the position or extension of a FLUSH event 710 where the vertical electrodes in the active area (V<17:1>) are manipulated to flush all charge to the V0 node where it is drained away. During integration time 720, the active area electrodes are held at constant potential.

At the time end of the integration time, a FRAME TX event 730 moves (transfers) all charge from the active region into the buffered region controlled by electrodes V<35:18>. The buffered region is sampled 740 while a new image is integrated at 750 in the active region after the flush 760. Sampling begins with resetting the floating diffusion (FD) by applying RT globally. Then each of the columns of the image sensor is sampled by the ADCs simultaneously before going onto the next row. After all rows are sampled, a TX signal is applied and the process repeats.

The values for each pixel are used for correlated sampling. This sequence of events may, for example, eliminate the need to implement a row decoder for each of the electrodes in the frame buffer and horizontal CCD regions. The digital values latched in the ADC are read out (e.g., 770) one column at a time by scanning through COL values during the integration cycle.

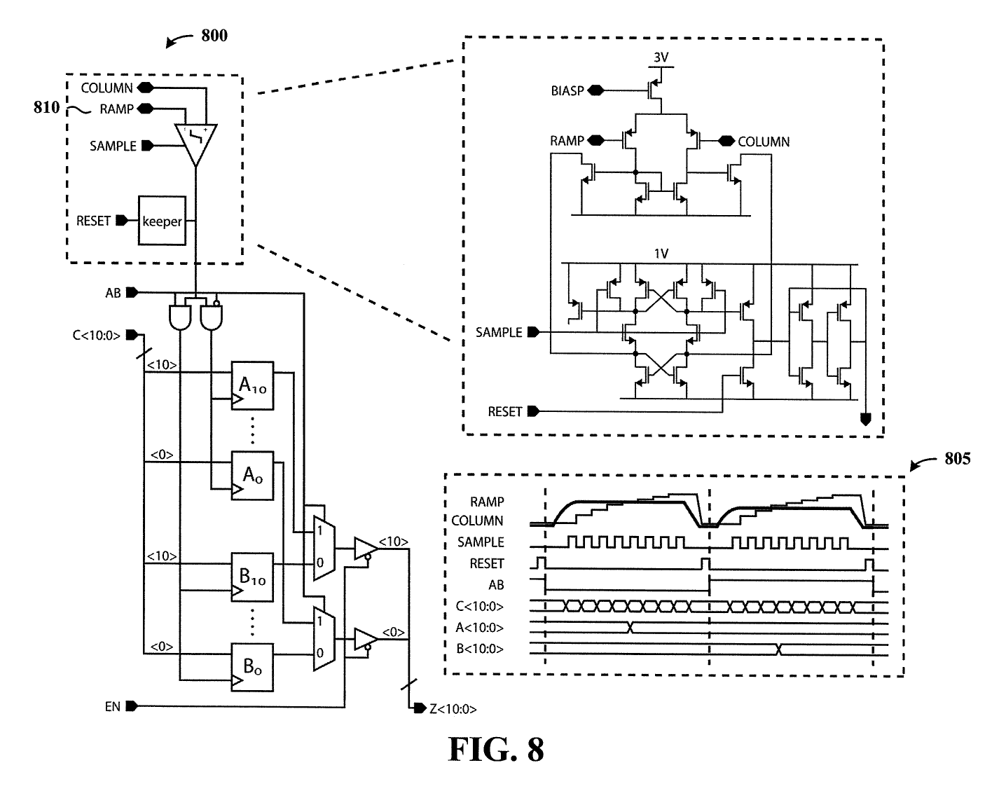

FIG. 8 shows a column-level analog-digital circuit (ADC) 800 with a timing diagram 805 for a multi-aperture imaging device, according to another example embodiment of the present invention. The approach shown in FIG. 8 may, for example, be implemented in accordance with the chip 500 in FIG. 5. An external ramp voltage 810 is applied along with a corresponding gray code during conversion. A comparator is operated with sufficient current to achieve 200 MHz sampling intervals at each step of the ramp. Although the ADC resolution is set for 11b, 256 codes are cycled during the conversion. The codes are linearly spaced at the upper end of the ramp but become more coarsely spaced near the bottom end to smoothly account for the increased shot noise level in the pixel. Sampling and reading out of the ADC at the same implements double buffering as shown.

In some embodiments, a vertical to horizontal transfer process such as described above is carried using one or more of the following approaches. In one application, individual charge packets are transferred into a H-CCD (horizontal CCD) one at a time. This involves moving all other charge forwards and then backwards in a V-CCD (vertical CCD). In another application, all even column charge packets are moved into a H-CCD while odd packets move backwards. The odd column charge packets are the moved into the H-CCD.

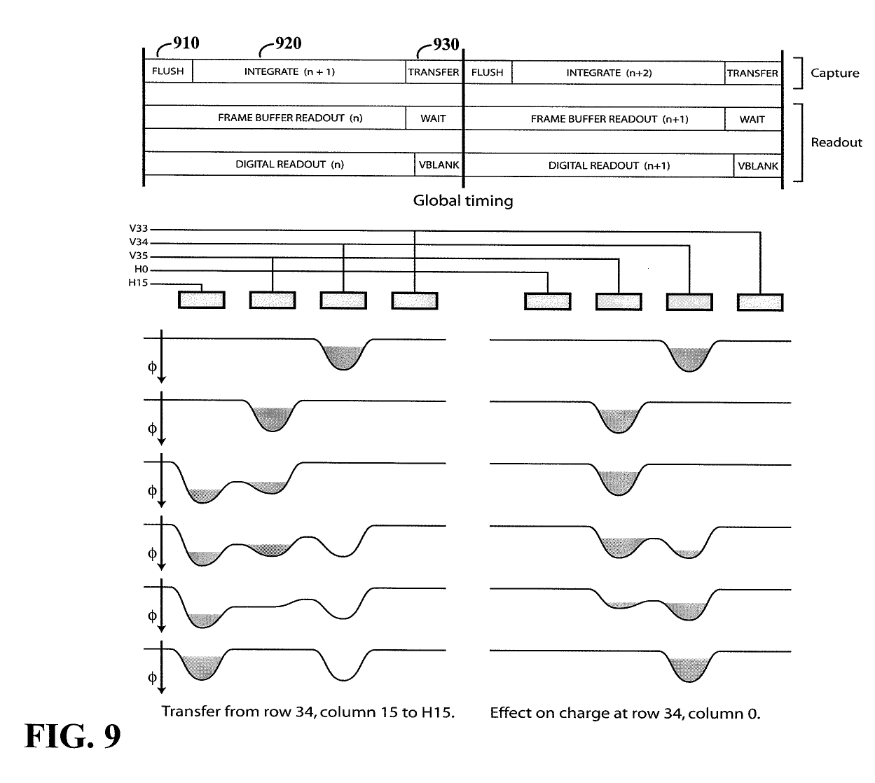

FIG. 9 shows a particular application for chip operation including vertical to horizontal transfer, for an integrated sensor chip having a plurality of rows and columns of disjoint sensors with CCD pixel arrays as described herein, according to another example embodiment of the present invention. The chip operation is divided into three phases: FLUSH, INTEGRATE, and TRANSFER respectively shown by way of example at 910, 920 and 930. Each frame includes 2 interlaced fields, and the capture of one field is performed at the same time that a previous field is being read out from the frame buffers.

During the FLUSH phase, CCD pixel arrays are depleted of charge through VO by sequencing V. During integration, pixel array electrodes are held at an intermediate voltage of 1V, and at the end of integration, the accumulated charge packets in the CCD pixel arrays are transferred one row at a time to the frame buffers using ripple charge transfer. A 2V potential difference between electrodes is used to achieve complete transfer between stages.

Frame buffer readout is performed while an INTEGRATION cycle takes place after a FLUSH cycle. The readout sequence begins with a global reset of all FD nodes through an RT pulse. The reset voltages are then digitized by per-column ADCs one aperture row at a time, and are stored off-chip. Next, one charge packet from each frame buffer is shifted to its H-CCD, which is performed by initially shifting one row of charge to the V35 electrode.

One of the horizontal electrodes (HI5 by way of example) is then set to a high voltage, which causes a partial charge transfer. Next, a vertical electrode (V34 by way of example) is brought to an intermediate voltage while another vertical electrode (V35 by way of example) is slowly brought to a lower voltage. The charge is transferred to H15 because the fringing field induced by H15 is larger than that induced by V34. This completes the transfer for the desired charge packet while all other charge is moved back under V34. The charge in the H-CCD is then ripple-shifted to H0 and onto the FD node while pulsing TX high. The pixel values on the FD nodes are digitized one row at a time by ADCs and stored off-chip where digital CDS is performed. This sequence is repeated until all stored pixel values for one field are read out. In some implementations, this readout approach is used to eliminate a need to implement a row decoder for each of the frame buffer and H-CCD electrodes.

Various other example embodiments are applicable to implementation in connection with those described in Appendices A-E of the above-referenced provisional application, which form part of the provisional application, and which are fully incorporated herein by reference. Other example embodiments are applicable to implementation in connection with those described in Keith Fife, Abbas El Gamal, H. -S. Philip Wong, “A 0.5_m Pixel Frame-Transfer CCD Image Sensor in 10 nm CMOS” (IEEE 2007); and in Keith Fife, Abbas El Gamal, H.-S. Philip Wong, “A 3MPixel Multi-Aperture Image Sensor with 0.7 μm Pixels in 0.11 μm CMOS” (IEEE International Electron Devices Meeting, pp. 1003-1006, December 2007; and further in ISSCC 2008, Session 2, Image Sensors & Technology, 2.3 (2008 IEEE International Solid-State Circuits Conference), all of which are fully incorporated herein by reference.

While the present invention has been described above and in the claims that follow, those skilled in the art will recognize that many changes may be made thereto without departing from the spirit and scope of the present invention. Such changes may include, for example, different arrangements of sensors, different spacing to facilitate selected sensor image overlap, different processing circuits and different optics. Other changes involve one or more aspects as described in the incorporated provisional patent application and the appendices that form part of the application. These and other approaches as described in the contemplated claims below characterize aspects of the present invention.

What is claimed is:

1. A method for imaging a scene, the method comprising:
using disjoint sensors beyond a designated focal plane to obtain multiple views of common points in the focal plane;
for the common points, processing the multiple views to compute a depth of field; and
using the computed depth of field to generate an image.

2. The method of claim 1, wherein using sensors includes using sensors that each have a different aperture and, for a subset of the sensors, obtaining a view of the common points.

3. The method of claim 1, wherein using disjoint sensors includes using light sensors that are spatially separated to mitigate cross-talk between the sensors.

4. The method of claim 1, wherein processing the multiple views includes processing data, for each sensor, using circuitry dedicated to and immediately adjacent to the sensor.

5. The method of claim 1, wherein processing the multiple views to compute a depth of field includes using a disparity between light data obtained for a common point in a scene at different apertures to determine the depth of field for the common point.

6. The method of claim 1, wherein processing the multiple views to compute a depth of field includes computing a depth of field for a particular point in a scene as a function of the position of the point in a view obtained at each sensor and of the number of sensors obtaining a view of the point.

7. The method of claim 1, prior to using the sensors to obtain multiple views, further including manufacturing an array of disjoint sensors on a semiconductor substrate, each sensor including a pixel array, readout circuitry and integrated optics, with the pixel array in each sensor being separated from pixel arrays in immediately adjacent sensors.

8. The method of claim 1, further including using a color filter at one of the sensors to filter light reaching the sensor.

9. The method of claim 1, wherein using disjoint sensors includes using an array of sensors, each sensor having a color filter and being separated from immediately adjacent sensors by a distance that is sufficient to mitigate color aliasing between immediately adjacent sensors.

10. The method of claim 1, wherein using disjoint sensors includes using light sensors that are physically separated by conductive materials that form a wall between the sensors to mitigate cross-talk therebetween.

11. A method for imaging a scene, the method comprising:
using a monolithic sensor arrangement having an array of optically disjoint sensors with sensor-specific integrated optics to re-image a focal plane formed from the scene.

12. The method of claim 11, wherein using an array of disjoint sensors includes using an array of disjoint sensors in a sensor plane that is offset from a focal plane for the scene.

13. The method of claim 11, wherein using a monolithic sensor arrangement having an array of optically disjoint sensors with sensor-specific integrated optics to re-image a focal plane includes using a correspondence difference between views of an object in the focal plane obtained using different sensors to determine a depth of field of the object.

14. The method of claim 11, wherein using a monolithic sensor arrangement having an array of optically disjoint sensors with sensor-specific integrated optics to re-image a focal plane includes processing generated light data from each sensor to compute an image of the scene.

15. An integrated image sensor circuit arrangement to image a scene, the circuit comprising:
a plurality of disjoint sensors in a sensor plane, each sensor including local integrated optics and pixels to re-image a focal plane formed from a scene.

16 The arrangement of claim 15, further including a lens arrangement to focus an image above the sensor plane to create overlapping fields of view between the sensors at the sensor plane to facilitate the generation of an image from each sensor that overlaps an image generated at immediately adjacent sensors in the array.

17. The arrangement of claim 15, further including an image processing circuit to combine data from the disjoint sensors to generate an image of the scene.

18. The arrangement of claim 17, wherein the image processing circuit
computes the depth of field of the scene using data from different pixels giving different perspectives of the scene, and
uses the computed depth of field to combine data from the sensors to generate an image of the scene.

19. The arrangement of claim 17, wherein
at least two sensors generate an image of a common object in the focal plane, and
the image processing circuit uses a disparity in position of the object in the images generated by each sensor to compute a depth of field of the object.

20. The arrangement of claim 17, wherein
at least two sensors generate an image of a common object in the focal plane, and
the image processing circuit uses a disparity in position of the object in the images generated by each sensor and the number of sensors that receive light corresponding to the common object to compute a depth of field of the object.

21. The arrangement of claim 15, wherein the sensors are formed on a monolithic substrate with each sensor separated from immediately adjacent sensors by a distance across the substrate.

22. The arrangement of claim 15, wherein the sensors are formed on a monolithic substrate with each sensor being separated from immediately adjacent sensors by a distance across the substrate, and wherein the local optics for each sensor are located above the sensor using a dielectric stack of the integrated image sensor circuit.

23. The arrangement of claim 15, wherein a subset of the sensors produce a stereo view of the focal plane that is used to compute the depth of field of an object in the view.

24. The arrangement of claim 15, further including different color filters that respectively filter light for different sensors.

25. The arrangement of claim 15, wherein each sensor includes a charge coupled device (CCD) array and a collector to transfer charge from the CCD by ripple readout into a local amplifier.

26. The arrangement of claim 15, wherein each sensor includes a charge coupled device (CCD) array, further including two phase imaging circuitry that facilitates carrier collection between gates on one phase and under gates on the next phase.

27. The arrangement of claim 15, wherein each sensor includes a charge coupled device (CCD) array to transfer charge from the CCD by moving charge forward and then backward in a vertically-located CCD to transfer charge packets into a horizontally-located CCD one at a time.

28. The arrangement of claim 15, wherein each sensor includes a charge coupled device (CCD) array to transfer charge from the CCD by transferring even column charge packets into a horizontally-located CCD while odd packets move backwards, and subsequently transferring odd column charge packets into the horizontally-located CCD.
